(19) United States
(12) Patent Application Publication
(10) Pub. No.: US 2013/0231893 A1
(43) Pub. Date: Sep. 5, 2013

(54) APPARATUS AND RELATED MONITORING SYSTEM

(71) Applicants: Christopher Edward Miller, Fletcher, NC (US); Stanley Frank Simpson, Simpsonville, SC (US)

(72) Inventors: Christopher Edward Miller, Fletcher, NC (US); Stanley Frank Simpson, Simpsonville, SC (US)

(73) Assignee: GENERAL ELECTRIC COMPANY, Schenectady, NY (US)

(21) Appl. No.: 13/409,887

(22) Filed: Mar. 1, 2012

(51) Int. Cl. F03B 13/00; G06F 15/00

(52) U.S. Cl. 702/182; 290/54

(57) ABSTRACT

Various embodiments include a turbine apparatus and a related monitoring system. In various embodiments, an apparatus includes a turbine rotor having: a rotor body; sets of rotor blades axially dispersed along the rotor body and extending radially from the rotor body; a spacer region axially separating two adjacent sets of the sets of rotor blades along the rotor body; a conductive element located within the spacer region for initiating an electrical current; and a module electrically connected with the conductive element for receiving the electrical current from the conductive element and powering at least one monitoring device onboard the rotor body.

### FIELD OF THE INVENTION

The subject matter disclosed herein relates to turbines. More particularly, aspects of the invention include an apparatus and a related monitoring system.

### BACKGROUND OF THE INVENTION

Conventional approaches to monitoring turbine operations can be hindered by the environmental operating conditions within a turbine (e.g., a gas turbine). In particular, electronic monitoring equipment, such as sensors and transmission devices, can have trouble functioning under the high operating temperatures within a gas turbine. Faults in these sensors can necessitate unscheduled repairs, shutdowns, or potentially prevent diagnosis of a turbine fault.

### BRIEF DESCRIPTION OF THE INVENTION

Various embodiments of the invention include an apparatus and a related monitoring system. In some embodiments, the apparatus includes a turbine rotor having: a rotor body; sets of rotor blades axially dispersed along the rotor body and extending radially from the rotor body; a spacer region axially separating two adjacent sets of the sets of rotor blades along the rotor body; a conductive element located within the spacer region for initiating an electrical current; and a module electrically connected with the conductive element for receiving the electrical current from the conductive element and powering at least one monitoring device onboard the rotor body.

A first aspect of the invention includes an apparatus having: a rotor body; sets of rotor blades axially dispersed along the rotor body and extending radially from the rotor body; a spacer region axially separating two adjacent sets of the sets of rotor blades along the rotor body; a conductive element located within the spacer region for initiating an electrical current; and a module electrically connected with the conductive element for receiving the electrical current from the conductive element and powering at least one monitoring device onboard the rotor body.

A second aspect of the invention includes an apparatus having: a turbine stator including: a stator body; a set of stator vanes extending radially from the stator body; and a magnet operably connected to a vane in the set of stator vanes; and a turbine rotor having: a rotor body and axially dispersed sets of rotor blades extending radially from the rotor body; a spacer region axially separating two adjacent sets of the sets of rotor blades along the rotor body; a conductive element located within the spacer region for initiating an electrical current from interaction with the magnet; and a module electrically connected with the conductive element for receiving the electrical current from the conductive element and powering at least one monitoring device onboard the rotor body.

A third aspect of the invention includes a monitoring system for an apparatus, the monitoring system including: at least one generating coil located on the apparatus, the at least one generating coil for initiating an electrical current in response to movement within a magnetic field; a sensor operably connected to the apparatus for sensing an operating condition of the apparatus; and a monitoring module electrically connected with the at least one generating coil and the sensor, the monitoring module configured to perform the following: receive the electrical current from the at least one generating coil and provide a power supply to the sensor; and receive sensor data from the sensor and provide the sensor data to an external data acquisition system.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows a schematic cut-away end view of a portion of an apparatus according to embodiments of the invention.

FIG. 2 shows a schematic cut-away side view of a portion of an apparatus according to embodiments of the invention.

FIG. 3 shows a close-up schematic cross-sectional view of a portion of an apparatus according to embodiments of the invention.

FIG. 4 shows a schematic view of a portion of a turbine monitoring system according to embodiments of the invention.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As noted, the subject matter disclosed herein relates to turbines. More particularly, aspects of the invention include a turbine apparatus and a related monitoring system.

Embodiments of the invention include a self-powered apparatus monitoring system (e.g., a turbine apparatus monitoring system) which is independent of external power sources. This system can utilize electric coils affixed to the turbine's rotor, and a corresponding magnet on the turbine's stator, to generate electric current within the coils. The electric current can be transmitted to monitoring devices, including, e.g., sensors, gauges, seals, etc. In various embodiments, a voltage regulator module can be used to regulate the transmitted power in the case that the voltage exceeds a desired level. In some cases, a rectifier can be employed when converting from alternating-current (AC) to direct-current (DC).

Various embodiments of the invention include an apparatus (e.g., a gas turbine compressor rotor) having: a rotor body; sets of rotor blades axially dispersed along the rotor body, those sets of rotor blades extending radially from the rotor body. The rotor can further include a spacer region axially separating two adjacent sets of the sets of rotor blades along the rotor body. The rotor can further include a conductive element located within the spacer region for initiating an electrical current; and a module electrically connected with the conductive element for receiving the electrical current from the conductive element and powering at least one monitoring device onboard the rotor body.

Various other embodiments of the invention include an apparatus (e.g., gas turbine compressor) having a turbine stator and a turbine rotor. The turbine stator can include: a stator body; a set of stator vanes extending radially from the stator body; and a magnet operably connected to a vane in the set of stator vanes. The turbine rotor can include: a rotor body and axially dispersed sets of rotor blades extending radially from the rotor body. The turbine rotor can further include a spacer region axially separating two adjacent sets of the sets of rotor blades along the rotor body. Additionally, the turbine rotor can include a conductive element located within the spacer region for initiating an electrical current from interaction with the magnet; and a module electrically connected with the conductive element for receiving the electrical current from the conductive element and powering at least one monitoring device onboard the rotor body.

Other embodiments of the invention include a monitoring system for an apparatus (e.g., a turbine apparatus, a valve, and/or a seal component), the monitoring system having: at least one generating coil located on the apparatus, the at least one generating coil for initiating an electrical current in response to movement within a magnetic field; a sensor operably connected to the apparatus for sensing an operating condition of the apparatus; and a monitoring module electrically connected with the at least one generating coil and the sensor, the monitoring module configured to perform the following: receive the electrical current from the at least one generating coil and provide a power supply to the sensor; and receive sensor data from the sensor and provide the sensor data to an external data acquisition system.

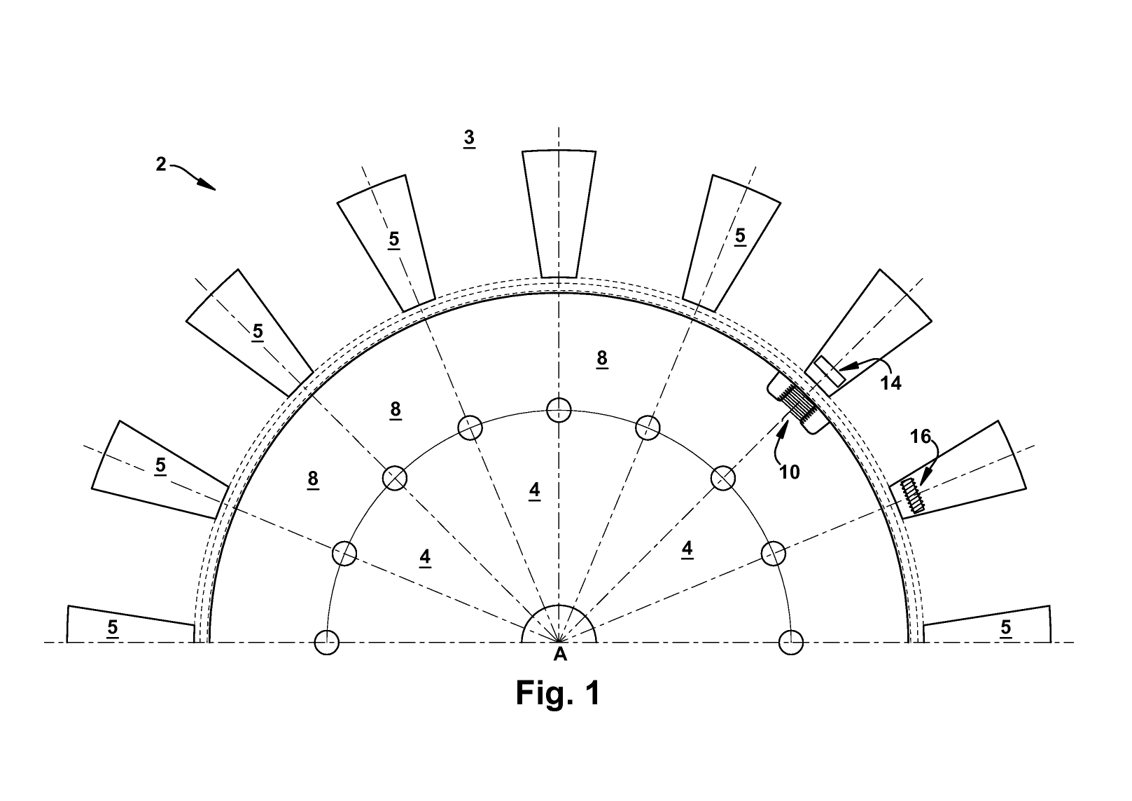

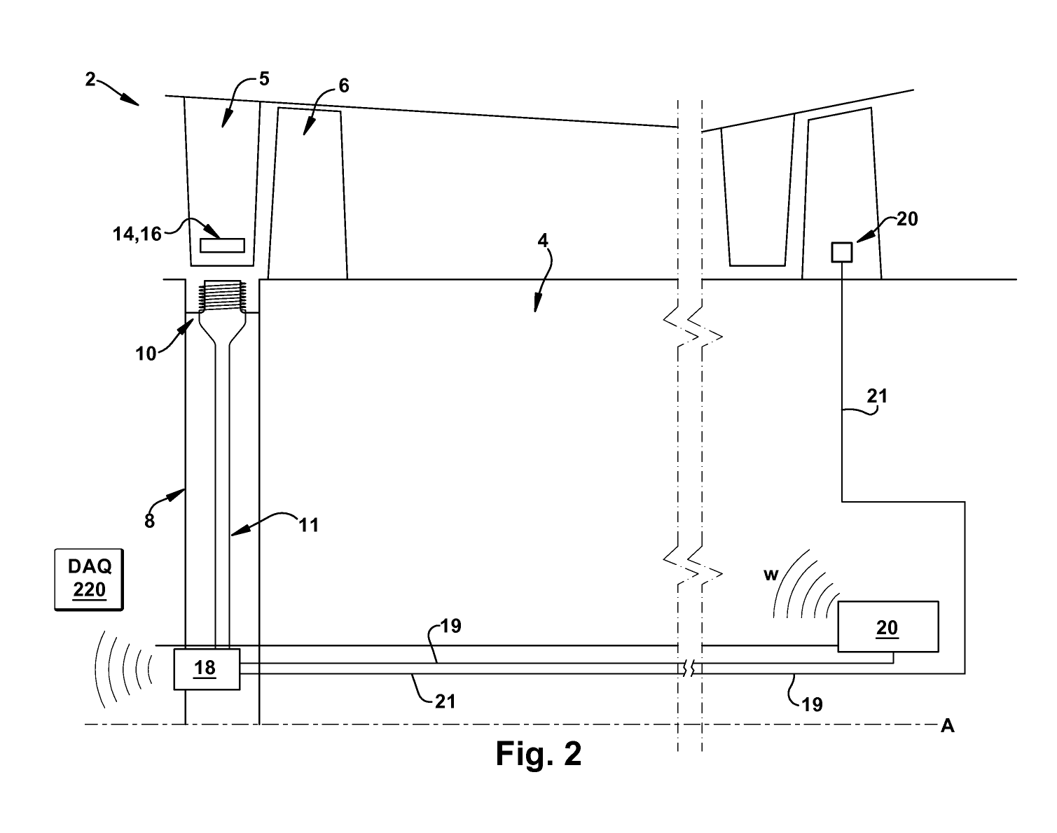

Turning to FIGS. 1-2, a schematic cut-away end view of a portion of an apparatus 2, and a schematic cut-away side view of a portion of the apparatus 2, respectively, are shown according to embodiments of the invention. In some cases, the apparatus 2 can include a gas turbine, and in some particular cases, the apparatus 2 can include a gas turbine compressor. Several of the views of the apparatus 2 omit features in the interest of clarity of illustration. These omissions should not be considered in any way to limit the invention disclosed herein.

As shown in FIGS. 1-2, the apparatus 2 can include a stator body 3 at least partially surrounding a rotor body 4. Where the apparatus 2 is a gas turbine (e.g., a gas turbine compressor), the apparatus 2 can further include axially dispersed sets of rotor blades 6 (FIG. 2) extending radially from the rotor body 4. These sets of rotor blades 6 can be dispersed axially, e.g., along an axis A of rotation of the rotor body 4. Axially interspersed between and separating adjacent (or, successive) sets of rotor blades 6 are respective spacer regions (or, spacer discs) 8 (FIGS. 1 and 2). The stator body 3 can include a plurality of stator vanes 5, arranged in axially dispersed sets (e.g., along the axis of the stator body, parallel with the axis A of rotation of the rotor body 4), with each vane 5 extending at least partially radially inward from the stator body 3. Also shown, the apparatus 2 can include a conductive element 10 (which can, in some cases, include a conductive coil) located within the spacer region 8 for initiating an electrical current, e.g., when moved with respect to a magnetic field. In some cases, the conductive element 10 can initiate an electrical current when moved relative to a fixed magnet located within the surrounding stator body 3. The fixed magnet can include or more permanent magnet(s) 14 and/or electromagnet(s) 16.

Also shown in FIG. 2, the apparatus 2 can include a monitoring module 18, or simply, module 18, which is electrically connected with the conductive element 10, e.g., via hard-wiring such as a coil output lead 11. The monitoring module 18 is configured to receive the electrical current initiated in the conductive element 10. In some cases, the monitoring module 18 is configured to power at least one monitoring device 20 (FIG. 2), which may be located onboard (e.g., physically affixed or otherwise attached to) the rotor body 4. The monitoring module 18 can provide a power supply, e.g., via lead lines 19, to the at least one monitoring device 20 in various embodiments. In certain embodiments, the at least one monitoring device 20 can provide data (e.g., operating condition data) to the monitoring module 18 via at least one signal lead line 21. In other embodiments, the at least one monitoring device 20 can transmit data (e.g., operating condition data such as temperature data, pressure data, moisture content data) wirelessly (indicated by wireless signal “w”) to the monitoring module 18. The monitoring device 20 can be any conventional sensor capable of monitoring an operating parameter of the apparatus 2, e.g., temperature gauges, pressure gauges, optical sensors, etc, (which may include one or more stress/strain gauges, piezo-electric sensors, etc.).

In some cases, the monitoring module 18 can be located in a different portion of the apparatus 2 (e.g., gas turbine) than the at least one monitoring device 20. That is, in some cases, the monitoring module 18 is located in a cold end of a turbine, where operating temperatures range from approximately 130 degrees Fahrenheit (F) to approximately 180 degrees F. In this case, the at least one monitoring device 20 can be located in a hot end of the turbine, where operating temperatures can exceed approximately 700 degrees F., and in some cases, can exceed 800 degrees F. In contrast to conventional monitoring systems, various aspects of the invention place much of the analytic circuitry and components in the monitoring module 18, which is located in a relatively low-temperature section of the apparatus 2. Because the monitoring module 18 is located in this lower-temperature area of the apparatus, it can be designed to include processing circuitry which may not withstand the operating temperatures in the hot end of the turbine, especially over the life cycle of that circuitry. Data is transmitted between the monitoring module 18 and the at least one monitoring device 20 via signal lead lines 19, which may run along the axis of the rotor body 4, and in some cases, may be affixed to or otherwise connected (e.g., via sleeves, clamps, integral pathways, etc.) to the rotor body 4.

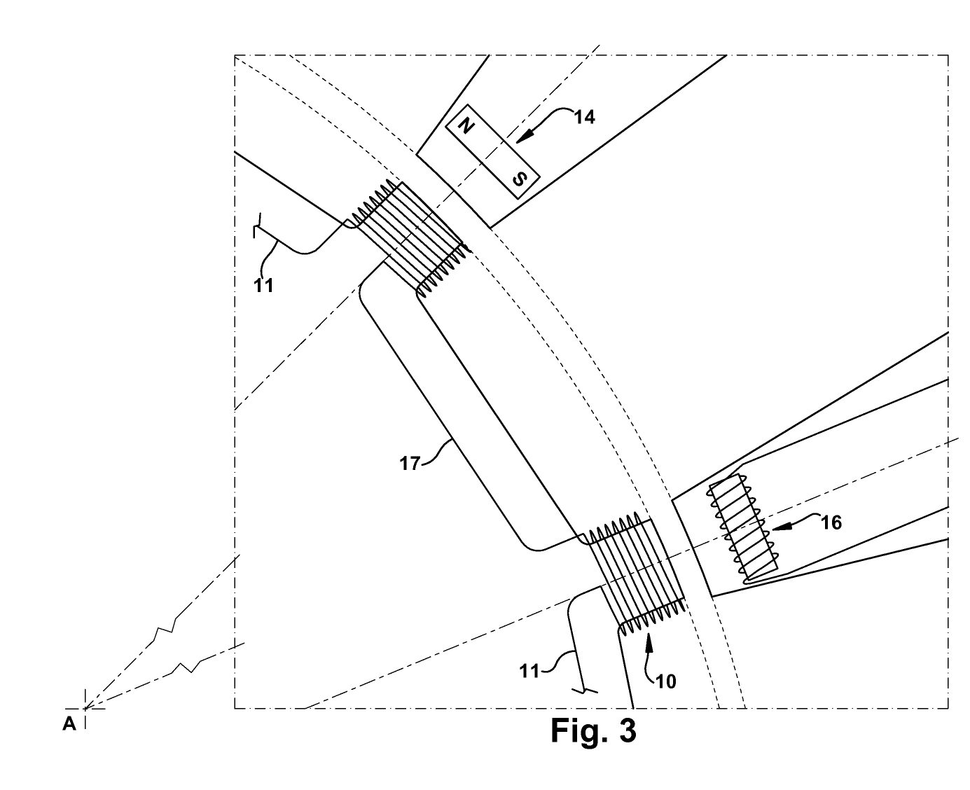

FIG. 3 shows a close-up cutaway view of portions of the apparatus 2, in particular, a plurality of conductive elements 10 located within a spacer region 8, and fixed magnets (e.g., a permanent magnet 14 and/or electromagnet 16, both depicted for illustrative purposes). As the rotor body 4 rotates during operation of the apparatus 2 (e.g., turbine) the conductive element 10 will move circumferentially within the stator body, and will pass in and out of one or more magnetic fields created by one or more permanent magnet(s) and/or electromagnet(s) 16. In some cases, as depicted in FIG. 3, a plurality of conductive elements 10 can be joined by a common lead line 17, which may be connected with other components in a monitoring system (e.g., monitoring module 18, FIG. 2).

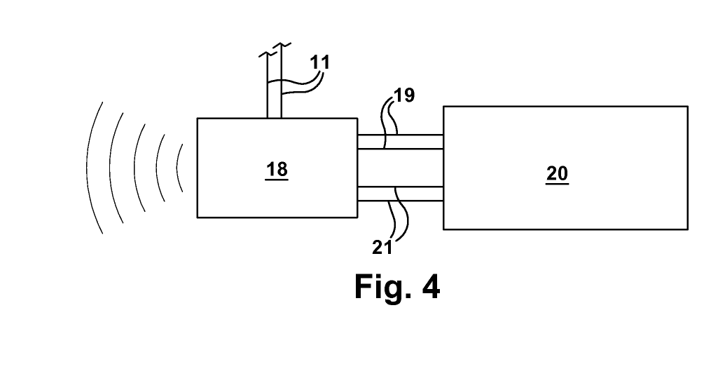

Turning to FIG. 4 a schematic view of the monitoring module and connected components are shown according to various embodiments of the invention. The monitoring module 18 can include one or more components for receiving the current transmitted from the conductive element 10, and serve as a power source for the at least one monitoring device 20. In some cases, the monitoring module 18 can include a voltage regulator, which can act to reduce the voltage of the current received from conductive element 10 before transmitting current to the at least one monitoring device 20. In some cases, the monitoring module 18 can include a rectifier for modifying the current type from that received from conductive element 10, e.g., by converting from alternating current (AC) to direct current (DC) or from DC to AC. In some cases, the type of rectifier, and hence, the type of current conversion, can be dictated by the at least one monitoring device 20. In various other cases, the monitoring module 18 can include a wireless receiver for receiving wireless signals from one or more sensors, e.g., the at least one monitoring device 20. The monitoring module 18 can further receive wireless signals from an external source (e.g., a testing device, not shown). Additionally, the monitoring module 18 can include a wireless transmitter for transmitting a wireless signal to an external source such as a data acquisition apparatus (or DAQ apparatus) 22. In still other embodiments, the monitoring module 18 can allow for two-way data communication between the monitoring module 18 and the at least one monitoring device 20. This allows the at least one monitoring device 20 to continuously transmit data to the monitoring module 18, which can in turn transmit that data (e.g., via its wireless transmitter) to the DAQ apparatus 22.

In contrast to conventional monitoring systems for turbines (e.g., gas turbines), aspects of the invention provide for a monitoring system which can provide reliable data about operating conditions of a turbine without the need for expensive, temperature resistant circuitry in the hot end of the turbine. The monitoring system described herein provides placement of analytic and communicative circuitry in the cold end of the turbine, thereby improving reliability and reducing costs when compared with conventional monitoring systems.

It is understood that the apparatuses described herein can be utilized according to various embodiments to generate electrical current from the movement of a number of apparatuses having one or more industrial components, e.g., valves, seals, etc. In these cases, the conductive element (e.g., conductive element 10) could be affixed to or in contact with any number of moving apparatus parts such as a valve flap, a seal seating, etc. The principles of operation of the electrical generation apparatus could remain substantially unchanged in these circumstances, and the apparatus could utilize the connection between the conductive element and the module as described herein. Additionally, the monitoring system could be used to monitor one or more of these types of apparatuses and/or components.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. It is further understood that the terms “front” and “back” are not intended to be limiting and are intended to be interchangeable where appropriate.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

We claim:

1. An apparatus comprising:
a rotor body;
sets of rotor blades axially dispersed along the rotor body and extending radially from the rotor body;
a spacer region axially separating two adjacent sets of the sets of rotor blades along the rotor body;
a conductive element located within the spacer region for initiating an electrical current; and
a module electrically connected with the conductive element for receiving the electrical current from the conductive element and powering at least one monitoring device onboard the rotor body.

2. The apparatus of claim 1, wherein the module includes at least one of a rectifier, a voltage regulator, a wireless receiver or a wireless transmitter.

3. The apparatus of claim 2, further comprising a lead line electrically connecting the conductive element and the module.

4. The apparatus of claim 1, further comprising a lead line electrically connecting the module and the at least one monitoring device.

5. The apparatus of claim 4, wherein the lead line is one of a power supply lead line or a signal lead line.

6. The apparatus of claim 1, wherein the at least one monitoring device includes a sensor selected from the group consisting of: a temperature gauge, a pressure gauge and an optical sensor.

7. The apparatus of claim 1, wherein the module includes a signal transmitter, and wherein the module is further configured to obtain data from the at least one monitoring device and transmit signals about the obtained data to an external data acquisition system.

8. An apparatus comprising:
a turbine stator including:
a stator body;
a set of stator vanes extending radially from the stator body; and
a magnet operably connected to a vane in the set of stator vanes; and
a turbine rotor having:
a rotor body and axially dispersed sets of rotor blades extending radially from the rotor body;
a spacer region axially separating two adjacent sets of the sets of rotor blades along the rotor body;
a conductive element located within the spacer region for initiating an electrical current from interaction with the magnet; and
a module electrically connected with the conductive element for receiving the electrical current from the conductive element and powering at least one monitoring device onboard the rotor body.

9. The apparatus of claim 8, wherein the module includes a wireless transmitter

10. The apparatus of claim 9, further comprising a data acquisition apparatus for acquiring data from the wireless transmitter.

11. The apparatus of claim 8, wherein the magnet includes at least one of a permanent magnet or an electromagnet.

12. The apparatus of claim 8, wherein the module includes at least one of a rectifier, a voltage regulator, a wireless receiver or a wireless transmitter.

13. The apparatus of claim 12, further comprising a lead line electrically connecting the conductive element and the module.

14. The apparatus of claim 8, further comprising a lead line electrically connecting the module and the at least one monitoring device.

15. The apparatus of claim 8, wherein the module includes a signal transmitter, and wherein the module is further configured to obtain data from the at least one monitoring device and transmit signals about the obtained data to an external data acquisition system.

16. A monitoring system for an apparatus, the monitoring system comprising:
at least one generating coil located on the apparatus, the at least one generating coil for initiating an electrical current in response to movement within a magnetic field;
a sensor operably connected to the apparatus for sensing an operating condition of the apparatus; and
a monitoring module electrically connected with the at least one generating coil and the sensor, the monitoring module configured to perform the following:
receive the electrical current from the at least one generating coil and provide a power supply to the sensor; and
receive sensor data from the sensor and provide the sensor data to an external data acquisition system.

17. The monitoring system of claim 16, wherein the sensor is one of a temperature gauge, a pressure gauge or an optical sensor.

18. The monitoring system of claim 16, wherein the monitoring module includes at least one of a rectifier, a voltage regulator, a wireless receiver or a wireless transmitter.

19. The monitoring system of claim 16, wherein the apparatus includes a turbine apparatus.
